(19) United States
(12) Patent Application Publication
(10) Pub. No.: US 2026/0187515 A1
(43) Pub. Date: Jul. 2, 2026

(54) COMPUTING A NOISE CHANNEL FOR A MULTI-QUBIT QUANTUM OPERATION DESCRIBED BY A LINDBLAD EQUATION

(71) Applicant: International Business Machines Corporation, Armonk, NY (US)

(72) Inventors: Moein Malek, Elmsford, NY (US); Ewout van den Berg, Bronxville, NY (US)

(21) Appl. No.: 19/002,830

(22) Filed: Dec. 27, 2024

(51) Int. Cl. G06N 10/70; G06N 10/20; G06N 10/40; G06N 10/60

(52) U.S. Cl. CPC G06N 10/70; G06N 10/20; G06N 10/40; G06N 10/60

(57) ABSTRACT

A method, system and computer program product for computing noise channels for multi-qubit quantum operations. The learned Lindbladian describing the dynamics of a multi-qubit operation is received. The learned Lindbladian refers to a Lindbladian operator that has been derived or learned from data, such as low-weight observable measurements. The learned Lindbladian is then analyzed, such as using the ideal gate Hamiltonian (H_{g}) on n qubits, to identify the noise terms. A noise channel is then computed using a perturbative approach based on the identified noise terms. Examples of the perturbation approach include the Magnus expansion or the Dyson expansion. By using such a perturbative method to compute the noise channel, such a computation is performed in a controlled manner which exploits the locality of noise to reduce the complexity yet results in an accurate noise channel that correctly predicts how the physical noise acts on the qubits.

### TECHNICAL FIELD

The present disclosure relates generally to quantum error mitigation/correction, and more particularly to computing a noise channel for a multi-qubit quantum operation described by a Lindblad equation.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation and quantum error correction techniques have been developed. Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation.

In order for quantum error mitigation and quantum error correction techniques to be successful, such techniques need a precise understanding of the noise channel that affects a layer of qubits. A noise channel represents the various environmental factors that can disrupt the delicate quantum states of qubits leading to errors in computation.

Such a noise channel may be computed using the Lindblad noise construction method, which computes the noise channel by exponentiating the learned Lindbladian (Lindbladian operator that has been derived or learned from data). The Lindblad noise construction method refers to a method for modeling noise within a quantum system using the Lindblad master equation, where noise is represented by a set of operators called the “Lindblad operators” that describe the possible decay and decoherence processes affecting the quantum system thereby allowing for the calculation of how a quantum state evolves over time under the influence of noise. Unfortunately, the calculation of exponentiating the learned Lindbladian becomes more complex as the number of qubits increases thereby making such a calculation impractical for large quantum systems.

As a result, there is not currently a means for effectively computing a noise channel for a multi-qubit quantum operation.

### SUMMARY

In one embodiment of the present disclosure, a method for computing noise channels for multi-qubit quantum operations comprises receiving a learned Lindbladian describing dynamics of a multi-qubit operation. The method further comprises analyzing the learned Lindbladian to identify noise terms. The method additionally comprises computing a noise channel using a perturbative approach based on the identified noise terms.

Furthermore, in one embodiment of the present disclosure, the noise channel is computed using a Magnus expansion or a Dyson expansion as the perturbative approach.

Additionally, in one embodiment of the present disclosure, the method further comprises grouping noise terms in the learned Lindbladian in terms of coherent and incoherent contributions, which are categorized in orders of locality.

Furthermore, in one embodiment of the present disclosure, the method additionally comprises decomposing the learned Lindbladian into a sum of underlying weight-k coherent and incoherent processes up to weight-k terms, where the weight-k specifies support of a coherent or incoherent Lindblad term involving k neighboring qubits.

Additionally, in one embodiment of the present disclosure, the method further comprises analyzing the learned Lindbladian to identify the noise terms using an ideal gate Hamiltonian on n qubits.

Furthermore, in one embodiment of the present disclosure, the noise channel is computed using the perturbative approach based on the analyzed Lindbladian by approximating noise due to each process independently up to a first order, where the noise channel is computed based on a product of each approximate noise due to each process.

Additionally, in one embodiment of the present disclosure, the method further comprises selecting a quantum error mitigation technique or a quantum error correction technique to be performed on a quantum circuit run on a quantum hardware based on the computed noise channel.

Other forms of the embodiments of the method described above are in a system and in a computer program product.

Accordingly, embodiments of the present disclosure compute the noise channel in a controlled manner which exploits the locality of noise to reduce the complexity yet results in an accurate noise channel that correctly predicts how the physical noise acts on the qubits.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for using a perturbative approach to compute the noise channel in a controlled manner based on the multi-qubit quantum operation described by a Lindblad equation in accordance with an embodiment of the present disclosure;

FIG. 3 illustrates the process for computing a noise channel in a controlled manner based on the multi-qubit quantum operation described by a Lindblad equation in accordance with an embodiment of the present disclosure;

FIG. 4 illustrates the numerical estimation of the noise via Magnus and Dyson perturbation in accordance with an embodiment of the present disclosure;

FIG. 5 illustrates generic (physics-agnostic) noise synthesis/construction in accordance with an embodiment of the present disclosure;

FIG. 6 illustrates physics-inspired noise synthesis/construction in accordance with an embodiment of the present disclosure;

FIG. 7 illustrates identifying the physical parameters that explain the measured noise in accordance with an embodiment of the present disclosure;

FIG. 8 illustrates an embodiment of the present disclosure of the hardware configuration of the classical computer which is representative of a hardware environment for practicing the present disclosure;

FIG. 9 is a flowchart of a method for using a perturbative approach to compute the noise channel in a controlled manner based on the multi-qubit quantum operation described by a Lindblad equation in accordance with an embodiment of the present disclosure; and

FIG. 10 is a flowchart of a method for identifying the noise terms by analyzing the learned Lindbladian ( [symbol] ) using the ideal gate Hamiltonian (H_{g}) on n qubits in accordance with an embodiment of the present disclosure.

### DETAILED DESCRIPTION

In one embodiment of the present disclosure, a method for computing noise channels for multi-qubit quantum operations comprises receiving a learned Lindbladian describing dynamics of a multi-qubit operation. The method further comprises analyzing the learned Lindbladian to identify noise terms. The method additionally comprises computing a noise channel using a perturbative approach based on the identified noise terms.

In this manner, the noise channel is computed in a controlled manner which exploits the locality of noise to reduce the complexity yet results in an accurate noise channel that correctly predicts how the physical noise acts on the qubits.

Furthermore, in one embodiment of the present disclosure, the noise channel is computed using a Magnus expansion or a Dyson expansion as the perturbative approach.

In this manner, the noise channel can be constructed in a controlled manner.

Additionally, in one embodiment of the present disclosure, the method further comprises grouping noise terms in the learned Lindbladian in terms of coherent and incoherent contributions, which are categorized in orders of locality.

In this manner, the separation of the ideal part of the quantum system (i.e., the pure, theoretical behavior of the quantum system) from the noise part of the quantum system (i.e., the random fluctuations and disturbances that occur) can be performed efficiently.

Furthermore, in one embodiment of the present disclosure, the method additionally comprises decomposing the learned Lindbladian into a sum of underlying weight-k coherent and incoherent processes up to weight-k terms, where the weight-k specifies support of a coherent or incoherent Lindblad term involving k neighboring qubits.

In this manner, the computation of the interaction-frame Lindbladian with respect to the ideal gate Hamiltonian on n qubits is easier to be performed.

Additionally, in one embodiment of the present disclosure, the method further comprises analyzing the learned Lindbladian to identify the noise terms using an ideal gate Hamiltonian on n qubits.

In this manner, the ideal part of the quantum system (i.e., the pure, theoretical behavior of the quantum system) is separated from the noise part of the quantum system (i.e., the random fluctuations and disturbances that occur).

Furthermore, in one embodiment of the present disclosure, the noise channel is computed using the perturbative approach based on the analyzed Lindbladian by approximating noise due to each process independently up to a first order, where the noise channel is computed based on a product of each approximate noise due to each process.

In this manner, the noise channel for a multi-qubit quantum operation can be efficiently computed.

Additionally, in one embodiment of the present disclosure, the method further comprises selecting a quantum error mitigation technique or a quantum error correction technique to be performed on a quantum circuit run on a quantum hardware based on the computed noise channel.

In this manner, a quantum error mitigation technique or a quantum error correction technique may be successfully applied to the quantum circuit run on quantum hardware due to the precise understanding of the noise channel.

Other forms of the embodiments of the method described above are in a system and in a computer program product.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation and quantum error correction techniques have been developed. Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation.

In order for quantum error mitigation and quantum error correction techniques to be successful, such techniques need a precise understanding of the noise channel that affects a layer of qubits. A noise channel represents the various environmental factors that can disrupt the delicate quantum states of qubits leading to errors in computation.

Such a noise channel may be computed using the Lindblad noise construction method, which computes the noise channel by exponentiating the learned Lindbladian (Lindbladian operator that has been derived or learned from data). The Lindblad noise construction method refers to a method for modeling noise within a quantum system using the Lindblad master equation, where noise is represented by a set of operators called the “Lindblad operators” that describe the possible decay and decoherence processes affecting the quantum system thereby allowing for the calculation of how a quantum state evolves over time under the influence of noise. Unfortunately, the calculation of exponentiating the learned Lindbladian becomes more complex as the number of qubits increases thereby making such a calculation impractical for large quantum systems.

As a result, there is not currently a means for effectively computing a noise channel for a multi-qubit quantum operation.

The embodiments of the present disclosure provide the means for effectively computing a noise channel for a multi-qubit quantum operation by analyzing a learned Lindbladian describing the dynamics of a multi-qubit operation to identify noise terms. In one embodiment, such noise terms are identified by analyzing the learned Lindbladian using an ideal gate Hamiltonian on n qubits. As a result of such an analysis, the noise terms in the learned Lindbladian are grouped in terms of coherent (Hamiltonian) and incoherent (dissipator) contributions, which are further categorized in orders of locality (Pauli weight). Grouping the noise terms in terms of coherent and incoherent contributions, as used herein, refers to identifying which terms that represent noise that preserves phase relationships (coherency) and which terms destroy phase information leading to decoherence (incoherency). Categorizing the coherent and incoherent noise terms in orders of locality (Pauli weight), as used herein, refers to classifying such noise terms based on their locality (i.e., how many qubits they affect). Such noise terms may then be separated using the ideal gate Hamiltonian on n qubits. A perturbative approach is then used to compute the noise channel based on such identified noise terms. An example of such a perturbative approach includes the Magnus expansion or the Dyson expansion. The Magnus expansion provides an exponential representation of the solution to a first-order homogeneous linear differential equation. The Dyson expansion involves expressing the time evolution operator as an infinite sum of terms, each representing a sequence of interactions occurring at different times thereby effectively describing how a quantum system evolves under a perturbation (small, controllable change or disturbance) over time. By using such a perturbative method to compute the noise channel, such a computation is performed in a controlled manner which exploits the locality of noise to reduce the complexity yet results in an accurate noise channel that correctly predicts how the physical noise acts on the qubits. These and other features will be discussed in further detail below.

In some embodiments of the present disclosure, the present disclosure comprises a method, system and computer program product for computing noise channels for multi-qubit quantum operations. In one embodiment of the present disclosure, the learned Lindbladian describing the dynamics of a multi-qubit operation is received. A Lindbladian, as used herein, refers to a mathematical operator used to describe the evolution of an open quantum system, such as describing how a quantum system's density matrix changes over time when interacting with its environment. The learned Lindbladian, as used herein, refers to a Lindbladian operator that has been derived or learned from data, such as low-weight observable measurements. The learned Lindbladian is then analyzed, such as using the ideal gate Hamiltonian (H_{g}) on n qubits, to identify the noise terms. In one embodiment, such noise terms are identified by computing the interaction-frame Lindbladian with respect to the ideal gate Hamiltonian (H_{g}) on n qubits. A noise channel is then computed using a perturbative approach based on the identified noise terms. A perturbation, as used herein, refers to a small, controllable change or disturbance added to a quantum system so as to analyze how the original quantum system is affected by this added perturbation. Examples of the perturbation approach used to compute the noise channel include the Magnus expansion or the Dyson expansion. The Magnus expansion provides an exponential representation of the solution to a first-order homogeneous linear differential equation. The Dyson expansion involves expressing the time evolution operator as an infinite sum of terms, each representing a sequence of interactions occurring at different times thereby effectively describing how a quantum system evolves under a perturbation over time. By using such a perturbative method to compute the noise channel, such a computation is performed in a controlled manner which exploits the locality of noise to reduce the complexity yet results in an accurate noise channel that correctly predicts how the physical noise acts on the qubits.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

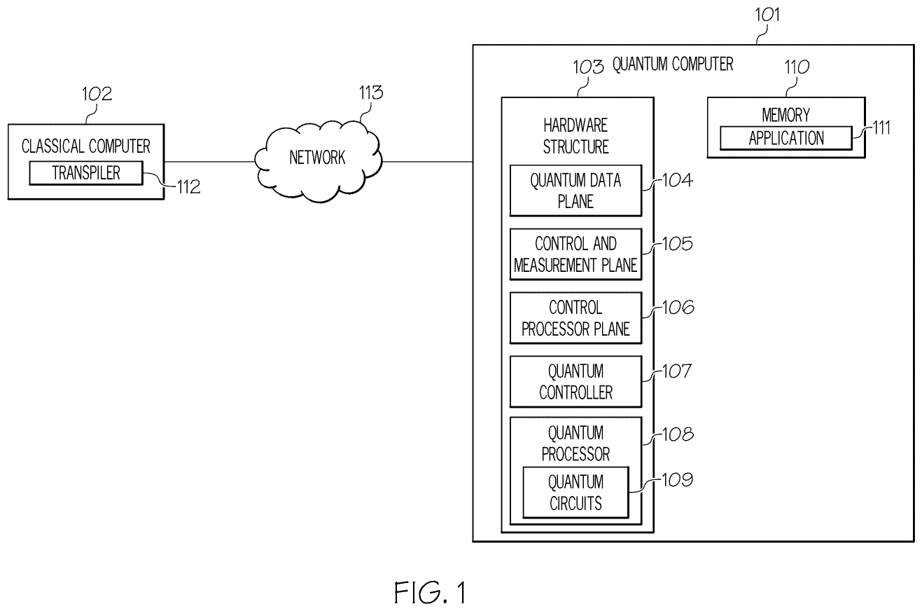

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to use a perturbative approach to compute the noise channel in a controlled manner based on the multi-qubit quantum operation described by a Lindblad equation.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

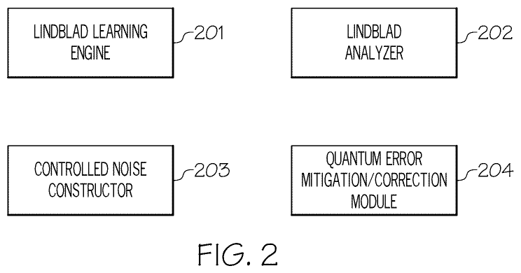

In one embodiment, memory 110 stores an application 111 that may be configured to implement one or more of the methods described herein in accordance with one or more embodiments. For example, application 111 may implement a program for using a perturbative approach to compute the noise channel in a controlled manner based on the multi-qubit quantum operation described by a Lindblad equation as discussed further below in connection with FIGS. 2-7 and 9-10. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

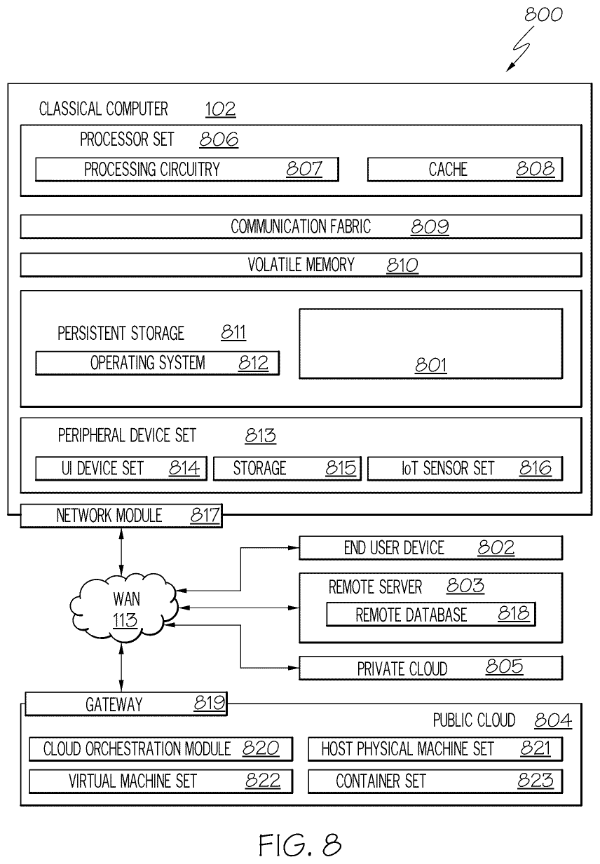

Furthermore, classical computer 102 is configured to use a perturbative approach to compute the noise channel in a controlled manner based on the multi-qubit quantum operation described by a Lindblad equation as discussed further below in connection with FIGS. 2-7 and 9-10. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for using a perturbative approach to compute the noise channel in a controlled manner based on the multi-qubit quantum operation described by a Lindblad equation is provided below in connection with FIG. 2.

FIG. 2 is a diagram of the software components of classical computer 102 (FIG. 1) for using a perturbative approach to compute the noise channel in a controlled manner based on the multi-qubit quantum operation described by a Lindblad equation in accordance with an embodiment of the present disclosure.

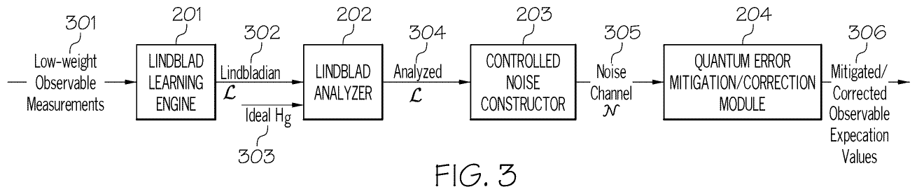

Referring to FIG. 2, in conjunction with FIG. 1, classical computer 102 includes a Lindblad learning engine 201 configured to generate a “learned Lindbladian.” A learned Lindbladian, as used herein, refers to a Lindbladian operator that has been derived or learned from data, such as low-weight observable measurements as illustrated in FIG. 3.

FIG. 3 illustrates the process for computing a noise channel in a controlled manner based on the multi-qubit quantum operation described by a Lindblad equation in accordance with an embodiment of the present disclosure.

As shown in FIG. 3, Lindblad learning engine 201 computes the learned Lindbladian 302 ( [symbol] ) based on low-weight observable measurements 301.

In one embodiment, Lindblad learning engine 201 computes the learned Lindbladian 302 based on low-weight observable measurements 301 using a technique called “classical shadow tomography,” which involves a series of randomized measurements on the quantum system, where the collected data is used to reconstruct the Lindbladian by fitting the measured expectation values to the theoretical evolution equation. A Lindbladian, as used herein, refers to a mathematical operator used to describe the evolution of an open quantum system, such as describing how a quantum system's density matrix changes over time when interacting with its environment. In one embodiment, Lindblad learning engine 201 fits the measured expectation values to the theoretical evolution equation by solving a system of linear equations with constraints based on the measured low-weight observables. In one embodiment, such low-weight observables correspond to a set of Pauli operators with low weight (i.e., they act on a small number of system components) that can be measured experimentally.

The learned Lindbladian includes the noise in addition to the ideal operation. As a result, noise construction involves the computation of the Lindblad noise channel as discussed herein. As previously discussed, the exact computation of the Lindblad noise channel becomes intractable for large number of qubits (e.g., dimension of 4″×4″, where n is the number of qubits). As a result, the separation of the ideal part of the quantum system (i.e., the pure, theoretical behavior of the quantum system) from the noise part of the quantum system (i.e., the random fluctuations and disturbances that occur) is performed. In order for such a separation to be performed efficiently, the principles of the present disclosure utilize frame transformations as discussed further below.

Returning to FIG. 2, in conjunction with FIGS. 1 and 3, classical computer 102 further includes Lindblad analyzer 202 configured to analyze the learned Lindbladian, including a decomposed learned Lindbladian, using an ideal gate Hamiltonian on n qubits to identify the noise terms.

In one embodiment, Lindblad analyzer 202 receives the learned Lindbladian describing the dynamics of a multi-qubit operation from Lindblad learning engine 201 as illustrated in FIG. 3.

In one embodiment, Lindblad analyzer 202 optionally decomposes the learned Lindbladian into a sum of underlying weight-k coherent and incoherent processes up to weight-k terms. In one embodiment, Lindblad analyzer 202 decomposes the learned Lindbladian into a sum of simpler terms, where each term represents a coherent (reversible) quantum process or an incoherent (irreversible) process with the weight-k specifying the support of a coherent or incoherent Lindblad term involving k neighboring qubits, where k is an integer representing the complexity of the interaction.

In one embodiment, Lindblad analyzer 202 decomposes the learned Lindbladian into a sum of underlying weight-k coherent and incoherent processes where the Lindbladian is expressed as a linear combination of “jump operators” that represent individual quantum events. These operators are then grouped based on their weight (the number of system operators involved in the interaction) to identify coherent and incoherent processes of different orders (k).

In one embodiment, Lindblad analyzer 202 analyzes the learned Lindbladian ( [symbol] ) 302, including the optional decomposed learned Lindbladian, using the ideal gate Hamiltonian (H_{g}) 303 on n qubits to identify the noise terms.

In one embodiment, Lindblad analyzer 202 identifies the noise terms by analyzing the learned Lindbladian ( [symbol] ) 302 using the ideal gate Hamiltonian (H_{g}) 303 on n qubits by grouping the noise terms of the learned Lindbladian 302 in terms of coherent (Hamiltonian) and incoherent (dissipator) contributions.

In one embodiment, such grouping forms the analyzed Lindbladian ( [symbol] ) 304. Grouping the noise terms of the learned Lindbladian 302 in terms of coherent and incoherent contributions, as used herein, refers to identifying which terms that represent noise that preserves phase relationships (coherency) and which terms destroy phase information leading to decoherence (incoherency).

Furthermore, in one embodiment, Lindblad analyzer 202 categorizes the grouped noise terms in orders of locality (Pauli weight).

Categorizing the grouped coherent and incoherent noise terms in orders of locality (Pauli weight), as used herein, refers to classifying such terms based on their locality (i.e., how many qubits they affect).

For example, weight-1 may be assigned to local terms and weight-2 may be assigned to non-local terms. When considering a set of quantum operations represented by Pauli matrices, those operations that affect a single qubit (i.e., have a weight of 1) are considered “local,” whereas, those operations that act on two different qubits are not considered neighbors or locally connected (i.e., non-local) and have a weight of 2.

Additionally, in one embodiment, Lindblad analyzer 202 of classical computer 102 separates the noise terms using the ideal gate Hamiltonian (H_{g}) 303 on n qubits.

For example, in one embodiment, Lindblad analyzer 202 analyzes the learned Lindbladian ( [symbol] ) 302 using the ideal gate Hamiltonian (H_{g}) 303 on n qubits to identify the noise terms by computing the interaction-frame Lindbladian with respect to the ideal gate Hamiltonian (H_{g}) on n qubits as

$${ℒ}_{1} ( t ) ≡ {𝒰}_{g}^{- 1} ( t ) L {𝒰}_{g} ( t ) ,$$

where [symbol] _{g}(t)≡exp(−iH_{g}t), where [symbol] represents the time-independent Lindbladian on n qubits. Such an interaction-frame Lindbladian is computed in order for the separation of the ideal part of the quantum system (i.e., the pure, theoretical behavior of the quantum system) from the noise part of the quantum system (i.e., the random fluctuations and disturbances that occur) to be performed efficiently.

For example, the interaction-frame representation provides a natural separation of energy scales into strong (gate) interaction and weak noise contributions. Depending on the choice of the unitary frame transformation, various decompositions are possible in which the noise could be decomposed on the left, the right, or the middle of ideal operations. In one embodiment, Lindblad analyzer 202 uses the standard noise decomposition as [symbol] ≡ [symbol] , where [symbol] , [symbol] , and [symbol] are the noisy operation, the noise, and the ideal unitary operation, respectively.

Separating the Hamiltonian as H=H_{g}+H_{δ} into the ideal Hg and the noise part H_{δ}, with Pauli decomposition

$${H}_{δ} ≡ {{\sum }^{\text{?}}}_{j} {δ}_{j} {P}_{j} ,$$

$$\text{?} \text{indicates text missing or illegible when filed}$$

the standard definition of the interaction frame representation is employed as

$${P}_{jI} ( t ) ≡ {e}^{+ {iH}_{\text{?}} t} {P}_{j} {e}^{- {iH}_{\text{?}} t} ,$$

$${ρ}_{I} ( t ) ≡ {e}^{+ {iH}_{\text{?}} t} ρ ( t ) {e}^{- {iH}_{\text{?}} t} ,$$

$$\text{?} \text{indicates text missing or illegible when filed}$$

where ρ_{I}(t) and P_{jI}(t) denote the transformed density matrix and the jth Pauli operator, respectively. The transformed density matrix therefore evolves only due to the noise

$${\dot{ρ}}_{I} ( t ) - {ℒ}_{I} {ρ}_{I} ( t ) ≡ - i [ {\sum }_{j} {δ}_{j} {P}_{jI} ( t ) , {ρ}_{I} ( t ) ] + {\sum }_{jk} {β}_{jk} ( {P}_{jI} ( t ) {ρ}_{I} ( t ) {P}_{kI}^{\text{?}} ( t ) - \frac{1}{2} \{ {P}_{kI}^{†} ( t ) {P}_{jI} ( t ) , {ρ}_{I} ( t ) \} ) .$$

$$\text{?} \text{indicates text missing or illegible when filed}$$

Under this definition of the interaction frame, the overall time evolution operation takes the form

$${\underbrace{\text{?}}}_{Noisy} = {\underbrace{{𝒰}_{g} ( {τ}_{g} )}}_{Ideal} {\underbrace{𝒯𝒸 {\int }_{0}^{\text{?}} {dt}^{′} {ℒ}_{I} ( {t}^{′} )}}_{Noise} , \qquad ( 1 )$$

$$\text{?} \text{indicates text missing or illegible when filed}$$

which is consistent with the standard circuit decomposition [symbol] ≡ [symbol] mentioned above. Here, [symbol] _{g}(τ_{g})=exp(−i [symbol] _{g},τ_{g}) is the ideal operation, τ_{δ} is the operation time, and τ denotes the time-ordering operator. In order to obtain the precise knowledge of the noise channel, Lindblad perturbation is utilized as discussed further below.

As discussed above, Lindblad analyzer 202 analyzes the learned Lindbladian ( [symbol] ) 302, including the optional decomposed learned Lindbladian, using the ideal gate Hamiltonian (H_{g}) 303 on n qubits to identify the noise terms as illustrated in FIG. 3. The output of such an analysis corresponds to an analyzed Lindbladian ( [symbol] ) 304 as further illustrated in FIG. 3.

Classical computer 102 further includes a controlled noise constructor 203 configured to implement a perturbative approach to compute the noise channel based on such identified noise terms, which, in one embodiment, are grouped in terms of coherent (Hamiltonian) and incoherent (dissipator) contributions and classified in orders of locality (Pauli weight) as illustrated in FIG. 3.

Referring to FIG. 3, in one embodiment, controlled noise constructor 203 computes noise channel 305 ( [symbol] ) using a perturbation approach given the analyzed Lindbladian 304.

A perturbation, as used herein, refers to a small, controllable change or disturbance added to a quantum system so as to analyze how the original quantum system is affected by this added perturbation. Examples of the perturbation approach utilized by controlled noise constructor 203 include, but are not limited to, the Magnus expansion or the Dyson expansion. The Magnus expansion provides an exponential representation of the solution to a first-order homogeneous linear differential equation. The Dyson expansion involves expressing the time evolution operator as an infinite sum of terms, each representing a sequence of interactions occurring at different times thereby effectively describing how a quantum system evolves under a perturbation over time.

In one embodiment, the time-dependent nature of the interaction-frame Lindbladian necessitates a time-dependent perturbation method. In such an embodiment, controlled noise constructor 203 employs the Magnus expansion, which computes an effective generator for the time evolution, and the corresponding Dyson series. By computing an effective generator, Magnus is in principle consistent with error mitigation protocols that are based on quasi-probabilistic implementation of the noise generator. Furthermore, the Magnus method is to some extent structure preserving as it preserves the trace and the Hermiticity, but not necessarily the positivity of the density matrix. Under the Magnus method, the noise in Equation (1) is computed as

$$𝒯 {e}^{\text{?}} = {e}^{\text{?}} , \qquad ( 2 )$$

$$\text{?} \text{indicates text missing or illegible when filed}$$

with Ω(t,0)=Ω₁(t,0)+Ω₂(t,0)+ . . . as the effective noise generator, which up to the second order it is approximated as

$${Ω}_{\text{?}} ( t , 0 ) = {\int }_{0}^{t} {dt}^{′} {ℒ}_{I} ( {t}^{′} ) ,$$

$${Ω}_{2} ( t , 0 ) = \frac{1}{2} {\int }_{0}^{t} {dt}^{′} {\int }_{0}^{t} {dt}^{″} [ {ℒ}_{I} ( {t}^{′} ) , {ℒ}_{I} ( {t}^{″} ) ] .$$

$$\text{?} \text{indicates text missing or illegible when filed}$$

Therefore, at the leading-order, the interaction-frame Lindbladian is integrated directly. Higher-order corrections appear as multi-time integrals of nested commutators of the Lindbladian at various times. For symbolic calculations, and for large dimensional problems, taking the full matrix exponential in Equation (2) is feasible for sufficiently simple noise models. Alternatively, the time evolution operator can be further expanded as:

$$𝒯 {e}^{\text{?}} = ℐ + {Ω}_{\text{?}} ( t , 0 ) + {Ω}_{2} ( t , 0 ) + \frac{1}{2} {Ω}_{\text{?}}^{2} ( t , 0 ) + 𝒪 ( {ℒ}_{\text{?}}^{3} ) . \qquad ( 3 )$$

$$\text{?} \text{indicates text missing or illegible when filed}$$

Equation (3) provides an unconventional, but very useful, representation of Dyson series in terms of Magnus series.

As a result of the foregoing, the use of Lindblad perturbation for noise construction serves as a generic noise construction module that takes the learned Lindbladian, without a consideration of its physical relevance, and outputs the resulting noise channel (e.g., noise channel 305 of FIG. 3).

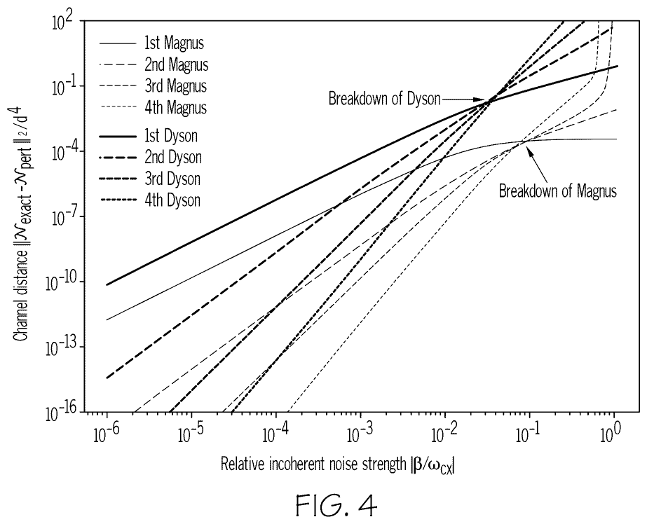

FIG. 4 illustrates the numerical estimation of the noise via Magnus and Dyson perturbation in accordance with an embodiment of the present disclosure.

Referring to FIG. 4, FIG. 4 shows the Frobenius distance of successive orders of Magnus/Dyson from an exact computation of the noise channel for a CX_{π/2} gate when scanning the strength of a dense random dissipator matrix. Below a relative noise strength threshold, the perturbation is convergent and higher-order corrections provide more precise estimates. In particular, Magnus demonstrates a higher threshold for convergence and also yields lower error at a given order in comparison to Dyson, but at a higher computational cost. In this example, below a threshold of approximately 10% for Magnus, the perturbation is convergent. In one embodiment, starting from physically relevant coherent and incoherent noise, controlled noise constructor 203 employs perturbation for deriving leading-order symbolic results. In particular, the commutator structure of the Magnus solution is an effective tool for an analytical description of the interplay between the underlying noise and ideal gate, and for predicting how the locality of the physical noise is transformed. As a result, noise construction is improved by predicting the expected non-zero terms for a given gate based on certain dominant noise mechanisms. Furthermore, resources can be saved as learning higher-weight Pauli-Lindblad (PL) fidelities becomes more expensive.

Returning to FIG. 2 in conjunction with FIG. 3, in one embodiment, controlled noise constructor 203 is configured to compute the noise channel (e.g., noise channel 305 of FIG. 3) using the perturbative approach based on the analyzed Lindbladian (e.g., analyzed Lindbladian 304) by approximating the noise due to each process independently up to a first order, where the noise channel (e.g., noise channel 305 of FIG. 3) is computed based on a product of each approximate noise due to each process. For example,

$$𝒩 \approx {\prod }_{k} exp ( {Ω}_{k}^{( 1 )} ) .$$

By using such a perturbative method to compute the noise channel, such a computation is performed in a controlled manner which exploits the locality of noise to reduce the complexity yet results in an accurate noise channel that correctly predicts how the physical noise acts on the qubits.

Classical computer 102 further includes quantum error mitigation/correction module 204 configured to perform quantum error mitigation or quantum error correction on a quantum circuit run on quantum hardware using the noise channel (e.g., noise channel 305 of FIG. 3) to enable the appropriate selection of the quantum error mitigation or quantum error correction technique to be implemented.

Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation.

As discussed above, in order for quantum error mitigation and quantum error correction techniques to be successful, such techniques need a precise understanding of the noise channel that affects a layer of qubits, where the noise channel predicts how the physical noise acts on the qubits.

Referring to FIG. 3, quantum error mitigation/correction module 204 uses the constructed noise channel 305 to select the appropriate quantum error mitigation or quantum error correction technique to be implemented as shown in element 306 (mitigated/corrected observable expectation values). For example, the constructed noise channel 305 feeds into the quantum error mitigation/correction of choice which runs specific quantum circuits on the quantum hardware. In one embodiment, a data structure (e.g. table) stores a listing of the appropriate quantum error mitigation/quantum error correction techniques to be performed on the quantum circuit based on the constructed noise channel 305. In one embodiment, quantum error mitigation/correction module 204 performs a look-up in such a data structure in order to select the appropriate quantum error mitigation/correction technique to be performed on the quantum circuit run on the quantum hardware based on the constructed noise channel 305. In one embodiment, such a data structure is populated by an expert. In one embodiment, such a data structure resides within the storage device of classical computer 102.

An example of a quantum error mitigation technique is the zero noise extrapolation technique. Zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Examples of a quantum error correction technique include the Shor code and the surface code, which are both designed to detect and correct errors, such as bit-flip and phase-flip errors, by distributing quantum information across multiple physical qubits allowing for error identification and correction through syndrome measurements.

Quantum error mitigation/correction module 204 utilizes various software tools for performing quantum error mitigation/correction in the manner discussed above, including, but are not limited to, Mitiq, Qiskit®, Cirq®, PyQuil®, etc.

Various applications of computing noise channels for multi-qubit quantum operations using the principles of the present disclosure are discussed below.

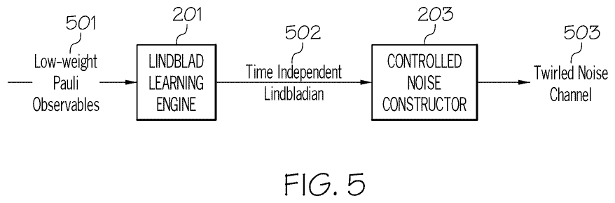

An example of one application is the generic (physics-agnostic) noise synthesis/construction as illustrated in FIG. 5.

FIG. 5 illustrates generic (physics-agnostic) noise synthesis/construction in accordance with an embodiment of the present disclosure.

As shown in FIG. 5, in conjunction with FIGS. 2-3, low-weight Pauli observables 501 are used by Lindblad learning engine 201 to generate a time independent Lindbladian 502. In one embodiment, low-weight Pauli observables 501 correspond to a set of Pauli operators with low weight (i.e., they act on a small number of system components) that can be measured experimentally. A time independent Lindbladian 502, as used herein, refers to a mathematical operator used to describe the evolution of an open quantum, where the operator itself does not change over time.

In one embodiment, controlled noise constructor 203 then computes the twirled noise channel 503 based on the time independent Lindbladian 502 using the principles of the present disclosure discussed above. In one embodiment, such an input time independent Lindbladian 502 is not necessarily separated into physically expected/meaningful Hamiltonian or dissipator terms. In one embodiment, the perturbative approach utilized by controlled noise constructor 203 to compute the twirled noise channel 503 corresponds to the Magnus expansion. A twirled noise channel 503, as used herein, refers to a noise channel that has been transformed through a process called “twirling,” which randomizes the noise by applying a set of random unitary operations (e.g., Pauli gates) effectively converting an arbitrary noise channel into a simpler, more structured noise channel (e.g., Pauli noise channel) making it easier to analyze and mitigate errors in quantum circuits.

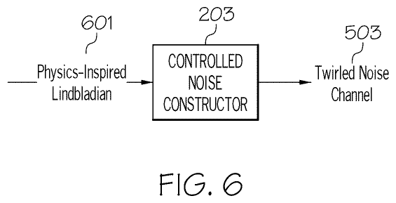

Another application of computing noise channels for multi-qubit quantum operations using the principles of the present disclosure is illustrated in FIG. 6.

FIG. 6 illustrates physics-inspired noise synthesis/construction in accordance with an embodiment of the present disclosure.

Referring to FIG. 6, in conjunction with FIGS. 2-3 and 5, controlled noise constructor 203 receives an input corresponding to a physics-inspired Lindbladian 601 (e.g., phase error, crosstalk, relaxation times). Based on such an input, controlled noise constructor 203 computes the twirled noise channel 503. A physics-inspired Lindbladian 601, as used herein, refers to a mathematical operator based on the Lindblad master equation, which describes the evolution of an open quantum system by incorporating realistic physical processes (e.g., energy dissipation, decoherence).

In a physics-inspired noise construction, certain coherent/incoherent noise processes are selected based on the knowledge of the specific quantum hardware under use.

In one embodiment, physics-inspired Lindbladian 601 is constructed using a Lindblad model, where the parameters of the Lindblad model are obtained from either the backend of the quantum hardware or measured in real-time before noise construction.

In one embodiment, controlled noise constructor 203 computes the twirled noise channel 503 based on the assumption that the first-order perturbation is valid thereby accounting for the noise of each process independently either numerically (assigning numerical values to represent the noise) or symbolically (assigning mathematical symbols or equations to represent the noise). Controlled noise constructor 203 then computes the aggregate noise channel (twirled noise channel 503) (generator) as the sum of the individual noise channels (generators).

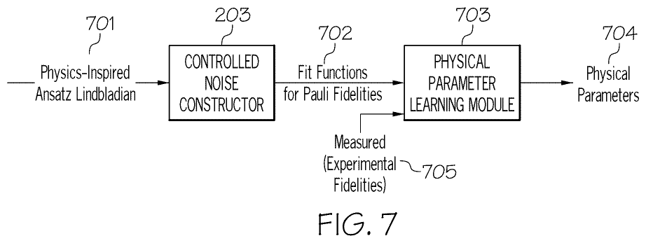

A further application of computing noise channels for multi-qubit quantum operations using the principles of the present disclosure is illustrated in FIG. 7.

FIG. 7 illustrates identifying the physical parameters that explain the measured noise in accordance with an embodiment of the present disclosure.

Referring to FIG. 7, in conjunction with FIGS. 2-3, controlled noise constructor 203 receives a physics-inspired Ansatz form of the Lindbladian 701, which refers to using the Lindbladian operator as an initial guess or starting point to study the dynamics of an open quantum system.

In one embodiment, controlled noise constructor 203 employs the noise construction discussed herein using the physics-inspired Ansatz Lindbladian 701 to derive fit functions for Pauli fidelities (see element 702). Fit functions for Pauli fidelities, as used herein, refer to mathematical functions used to estimate the fidelity of a quantum gate (e.g., Pauli gate) by fitting experimental data obtained from a characterization process.

Furthermore, as shown in FIG. 7, a physical parameter learning module 703 identifies the physical parameters 704 (e.g., phase error, crosstalk, relaxation times) based on the fit functions for Pauli fidelities 702 and the measured (experimental) fidelities 705. In one embodiment, physical parameter learning module 703 identifies the physical parameters 704 via maximum likelihood estimation. In such a statistical method, the values of physical parameters that best explain a set of quantum measurements (e.g., measurements 705) using the fit functions for Pauli fidelities 702 are identified.

By using the perturbative method of the present disclosure to compute the noise channel, such a computation is performed in a controlled manner which exploits the locality of noise to reduce the complexity yet results in an accurate noise channel that correctly predicts how the physical noise acts on the qubits. Furthermore, such a computed noise channel is a noise channel of multi-qubit operations that is predicted without the need for twirling.

Furthermore, the principles of the present disclosure enable either a full (untwirled) or twirled noise channel to be perturbatively constructed. Additionally, such constructed noise can be used as a local building block to stitch/construct the noise of larger quantum systems thereby being applicable to arbitrary quantum circuits.

A further description of these and other functions is provided below in connection with the discussion of the method for using a perturbative approach to compute the noise channel in a controlled manner based on the multi-qubit quantum operation described by a Lindblad equation.

Prior to the discussion of the method for using a perturbative approach to compute the noise channel in a controlled manner based on the multi-qubit quantum operation described by a Lindblad equation, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as using a perturbative approach to compute the noise channel in a controlled manner based on the multi-qubit quantum operation described by a Lindblad equation. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2-7 to use a perturbative approach to compute the noise channel in a controlled manner based on the multi-qubit quantum operation described by a Lindblad equation. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for using a perturbative approach to compute the noise channel in a controlled manner based on the multi-qubit quantum operation described by a Lindblad equation, may be embodied in an application-specific integrated circuit.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation. In order for quantum error mitigation and quantum error correction techniques to be successful, such techniques need a precise understanding of the noise channel that affects a layer of qubits. A noise channel represents the various environmental factors that can disrupt the delicate quantum states of qubits leading to errors in computation. Such a noise channel may be computed using the Lindblad noise construction method, which computes the noise channel by exponentiating the learned Lindbladian (Lindbladian operator that has been derived or learned from data). The Lindblad noise construction method refers to a method for modeling noise within a quantum system using the Lindblad master equation, where noise is represented by a set of operators called the “Lindblad operators” that describe the possible decay and decoherence processes affecting the quantum system thereby allowing for the calculation of how a quantum state evolves over time under the influence of noise. Unfortunately, the calculation of exponentiating the learned Lindbladian becomes more complex as the number of qubits increases thereby making such a calculation impractical for large quantum systems. As a result, there is not currently a means for effectively computing a noise channel for a multi-qubit quantum operation.

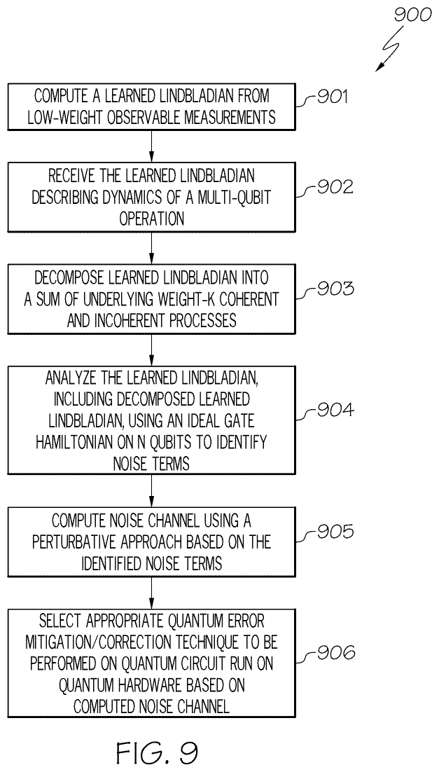

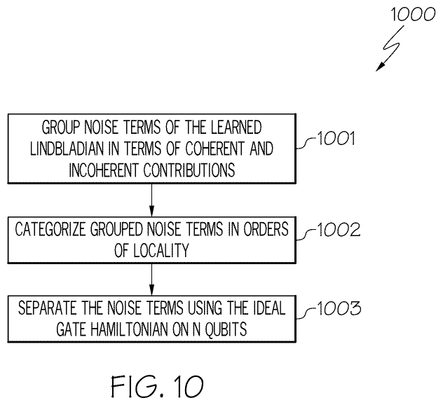

The embodiments of the present disclosure provide the means for effectively computing a noise channel for a multi-qubit quantum operation described by the Lindblad equation as discussed below in connection with FIGS. 9 and 10. FIG. 9 is a flowchart of a method for using a perturbative approach to compute the noise channel in a controlled manner based on the multi-qubit quantum operation described by a Lindblad equation. FIG. 10 is a flowchart of a method for identifying the noise terms by analyzing the learned Lindbladian ( [symbol] ) using the ideal gate Hamiltonian (H_{g}) on n qubits.

As stated above, FIG. 9 is a flowchart of a method 900 for using a perturbative approach to compute the noise channel in a controlled manner based on the multi-qubit quantum operation described by a Lindblad equation in accordance with an embodiment of the present disclosure.

Referring to FIG. 9, in conjunction with FIGS. 1-8, in step 901, Lindblad learning engine 201 of classical computer 102 computes the learned Lindbladian from low-weight observable measurements.

As discussed above, a learned Lindbladian, as used herein, refers to a Lindbladian operator that has been derived or learned from data, such as low-weight observable measurements as illustrated in FIG. 3.

As shown in FIG. 3, Lindblad learning engine 201 computes the learned Lindbladian 302 ( [symbol] ) based on low-weight observable measurements 301.

In one embodiment, Lindblad learning engine 201 computes the learned Lindbladian 302 based on low-weight observable measurements 301 using a technique called “classical shadow tomography,” which involves a series of randomized measurements on the quantum system, where the collected data is used to reconstruct the Lindbladian by fitting the measured expectation values to the theoretical evolution equation. A Lindbladian, as used herein, refers to a mathematical operator used to describe the evolution of an open quantum system, such as describing how a quantum system's density matrix changes over time when interacting with its environment. In one embodiment, Lindblad learning engine 201 fits the measured expectation values to the theoretical evolution equation by solving a system of linear equations with constraints based on the measured low-weight observables. In one embodiment, such low-weight observables correspond to a set of Pauli operators with low weight (i.e., they act on a small number of system components) that can be measured experimentally.

The learned Lindbladian includes the noise in addition to the ideal operation. As a result, noise construction involves the computation of the Lindblad noise channel as discussed herein. As previously discussed, the exact computation of the Lindblad noise channel becomes intractable for large number of qubits (e.g., dimension of 4″×4″, where n is the number of qubits). As a result, the separation of the ideal part of the quantum system (i.e., the pure, theoretical behavior of the quantum system) from the noise part of the quantum system (i.e., the random fluctuations and disturbances that occur) is performed. In order for such a separation to be performed efficiently, the principles of the present disclosure utilize frame transformations as discussed herein.

In step 902, Lindblad analyzer 202 of classical computer 102 receives the learned Lindbladian describing the dynamics of a multi-qubit operation from Lindblad learning engine 201.

In step 903, Lindblad analyzer 202 of classical computer 102 optionally decomposes the learned Lindbladian into a sum of underlying weight-k coherent and incoherent processes up to weight-k terms.

As stated above, in one embodiment, Lindblad analyzer 202 decomposes the learned Lindbladian into a sum of simpler terms, where each term represents a coherent (reversible) quantum process or an incoherent (irreversible) process with the weight-k specifying the support of a coherent or incoherent Lindblad term involving k neighboring qubits, where k is an integer representing the complexity of the interaction.

In one embodiment, Lindblad analyzer 202 decomposes the learned Lindbladian into a sum of underlying weight-k coherent and incoherent processes where the Lindbladian is expressed as a linear combination of “jump operators” that represent individual quantum events. These operators are then grouped based on their weight (the number of system operators involved in the interaction) to identify coherent and incoherent processes of different orders (k).

In step 904, Lindblad analyzer 202 of classical computer 102 analyzes the learned Lindbladian ( [symbol] ) 302, including the optional decomposed learned Lindbladian, using the ideal gate Hamiltonian (H_{g}) 303 on n qubits to identify the noise terms.

In one embodiment, Lindblad analyzer 202 identifies the noise terms by analyzing the learned Lindbladian ( [symbol] ) 302 using the ideal gate Hamiltonian (H_{g}) 303 on n qubits as discussed below in connection with FIG. 10.

FIG. 10 is a flowchart of a method 1000 for identifying the noise terms by analyzing the learned Lindbladian ( [symbol] ) 302 using the ideal gate Hamiltonian (H_{g}) 303 on n qubits in accordance with an embodiment of the present disclosure.

Referring to FIG. 10, in conjunction with FIGS. 1-9, in step 1001, Lindblad analyzer 202 of classical computer 102 groups the noise terms of the learned Lindbladian 302 in terms of coherent (Hamiltonian) and incoherent (dissipator) contributions.

As stated above, in one embodiment, such grouping forms the analyzed Lindbladian ( [symbol] ) 304. Grouping the noise terms of the learned Lindbladian 302 in terms of coherent and incoherent contributions, as used herein, refers to identifying which terms that represent noise that preserves phase relationships (coherency) and which terms destroy phase information leading to decoherence (incoherency).

In step 1002, Lindblad analyzer 202 of classical computer 102 categorizes the grouped noise terms in orders of locality (Pauli weight).

As discussed above, categorizing the grouped coherent and incoherent noise terms in orders of locality (Pauli weight), as used herein, refers to classifying such terms based on their locality (i.e., how many qubits they affect).

For example, weight-1 may be assigned to local terms and weight-2 may be assigned to non-local terms. When considering a set of quantum operations represented by Pauli matrices, those operations that affect a single qubit (i.e., have a weight of 1) are considered “local,” whereas, those operations that act on two different qubits are not considered neighbors or locally connected (i.e., non-local) and have a weight of 2.

In step 1003, Lindblad analyzer 202 of classical computer 102 separates the noise terms using the ideal gate Hamiltonian (H_{g}) 303 on n qubits.

As discussed above, in one embodiment, Lindblad analyzer 202 analyzes the learned Lindbladian ( [symbol] ) 302 using the ideal gate Hamiltonian (H_{g}) 303 on n qubits to identify the noise terms by computing the interaction-frame Lindbladian with respect to the ideal gate Hamiltonian (H_{g}) on n qubits as

$${ℒ}_{I} ( t ) ≡ {𝒰}_{g}^{- 1} ( t ) L {𝒰}_{g} ( t ) ,$$

where [symbol] _{g}(t)≡exp(−iH_{g}t), where [symbol] represents the time-independent Lindbladian on n qubits. Such an interaction-frame Lindbladian is computed in order for the separation of the ideal part of the quantum system (i.e., the pure, theoretical behavior of the quantum system) from the noise part of the quantum system (i.e., the random fluctuations and disturbances that occur) to be performed efficiently.

For example, the interaction-frame representation provides a natural separation of energy scales into strong (gate) interaction and weak noise contributions. Depending on the choice of the unitary frame transformation, various decompositions are possible in which the noise could be decomposed on the left, the right, or the middle of ideal operations. In one embodiment, Lindblad analyzer 202 uses the standard noise decomposition as [symbol] ≡ [symbol] , where [symbol] , N, and [symbol] ₐ are the noisy operation, the noise, and the ideal unitary operation, respectively.

Separating the Hamiltonian as H=H_{g}+H_{δ} into the ideal Hg and the noise part H_{δ}, with Pauli decomposition

$${H}_{δ} ≡ ≡ {{\sum }^{\text{?}}}_{j} {δ}_{j} {P}_{j} ,$$

$$\text{?} \text{indicates text missing or illegible when filed}$$

the standard definition of the interaction frame representation is employed as

$${P}_{jI} ( t ) ≡ {e}^{+ {H}_{\text{?}} t} {P}_{j} {e}^{- {H}_{\text{?}} t} ,$$

$${ρ}_{I} ( t ) ≡ {e}^{+ {H}_{\text{?}} t} ρ ( t ) {e}^{- {H}_{\text{?}} t} ,$$

$$\text{?} \text{indicates text missing or illegible when filed}$$

where ρ_{I}(t) and ρ_{jI}(t) denote the transformed density matrix and the jth Pauli operator, respectively. The transformed density matrix therefore evolves only due to the noise

$${\dot{ρ}}_{I} ( t ) - {ℒ}_{I} {ρ}_{I} ( t ) ≡ - i [ {\sum }_{j} {δ}_{j} {P}_{jI} ( t ) , {ρ}_{I} ( t ) ] + {\sum }_{jk} {β}_{jk} ( {P}_{jI} ( t ) {ρ}_{I} ( t ) {P}_{kI}^{\text{?}} ( t ) - \frac{1}{2} \{ {P}_{kI}^{†} ( t ) {P}_{jI} ( t ) , {ρ}_{I} ( t ) \} ) .$$

$$\text{?} \text{indicates text missing or illegible when filed}$$

Under this definition of the interaction frame, the overall time evolution operation takes the form

$${\underbrace{\text{?}}}_{Noisy} = {\underbrace{{𝒰}_{g} ( {τ}_{g} )}}_{Ideal} {\underbrace{𝒯𝒸 {\int }_{0}^{\text{?}} {dt}^{′} {ℒ}_{I} ( {t}^{′} )}}_{Noise} , \qquad ( 1 )$$

$$\text{?} \text{indicates text missing or illegible when filed}$$

which is consistent with the standard circuit decomposition [symbol] ≡ [symbol] mentioned above. Here, [symbol] _{g}(τ_{g})=exp(−i [symbol] _{g}τ_{g}) is the ideal operation, τₗ is the operation time, and τ denotes the time-ordering operator. In order to obtain the precise knowledge of the noise channel, Lindblad perturbation is utilized as discussed herein.

As discussed above, Lindblad analyzer 202 analyzes the learned Lindbladian ( [symbol] ) 302, including the optional decomposed learned Lindbladian, using the ideal gate Hamiltonian (H_{g}) 303 on n qubits to identify the noise terms as illustrated in FIG. 3. The output of such an analysis corresponds to an analyzed Lindbladian ( [symbol] ) 304 as further illustrated in FIG. 3.

Returning to FIG. 9, in conjunction with FIGS. 1-8, in step 905, controlled noise constructor 203 of classical computer 102 computes a noise channel using a perturbative approach based on the identified noise terms.

As stated above, controlled noise constructor 203 computes noise channel 305 (N) using a perturbation approach given the analyzed Lindbladian 304.

A perturbation, as used herein, refers to a small, controllable change or disturbance added to a quantum system so as to analyze how the original quantum system is affected by this added perturbation. Examples of the perturbation approach utilized by controlled noise constructor 203 include, but are not limited to, the Magnus expansion or the Dyson expansion. The Magnus expansion provides an exponential representation of the solution to a first-order homogeneous linear differential equation. The Dyson expansion involves expressing the time evolution operator as an infinite sum of terms, each representing a sequence of interactions occurring at different times thereby effectively describing how a quantum system evolves under a perturbation over time.

In one embodiment, the time-dependent nature of the interaction-frame Lindbladian necessitates a time-dependent perturbation method. In such an embodiment, controlled noise constructor 203 employs the Magnus expansion, which computes an effective generator for the time evolution, and the corresponding Dyson series. By computing an effective generator, Magnus is in principle consistent with error mitigation protocols that are based on quasi-probabilistic implementation of the noise generator. Furthermore, the Magnus method is to some extent structure preserving as it preserves the trace and the Hermiticity, but not necessarily the positivity of the density matrix. Under the Magnus method, the noise in Equation (1) is computed as

$$𝒯 {e}^{\text{?}} = {e}^{\text{?}} , \qquad ( 2 )$$

$$\text{?} \text{indicates text missing or illegible when filed}$$

with Ω(t,0)=Ωₜ(t,0)+Ω₂(t,0)+ . . . as the effective noise generator, which up to the second order it is approximated as

$${Ω}_{\text{?}} ( t , 0 ) = {\int }_{0}^{t} {dt}^{′} {ℒ}_{I} ( {t}^{′} ) ,$$

$${Ω}_{2} ( t , 0 ) = \frac{1}{2} {\int }_{0}^{t} {dt}^{′} {\int }_{0}^{t} {dt}^{″} [ {ℒ}_{I} ( {t}^{′} ) , {ℒ}_{I} ( {t}^{″} ) ] .$$

$$\text{?} \text{indicates text missing or illegible when filed}$$

Therefore, at the leading-order, the interaction-frame Lindbladian is integrated directly. Higher-order corrections appear as multi-time integrals of nested commutators of the Lindbladian at various times. For symbolic calculations, and for large dimensional problems, taking the full matrix exponential in Equation (2) is feasible for sufficiently simple noise models. Alternatively, the time evolution operator can be further expanded as:

$$𝒯 {e}^{\text{?}} = ℐ + {Ω}_{\text{?}} ( t , 0 ) + {Ω}_{2} ( t , 0 ) + \frac{1}{2} {Ω}_{\text{?}}^{2} ( t , 0 ) + 𝒪 ( {ℒ}_{\text{?}}^{3} ) . \qquad ( 3 )$$

$$\text{?} \text{indicates text missing or illegible when filed}$$

Equation (3) provides an unconventional, but very useful, representation of Dyson series in terms of Magnus series.

As a result of the foregoing, the use of Lindblad perturbation for noise construction serves as a generic noise construction module that takes the learned Lindbladian, without a consideration of its physical relevance, and outputs the resulting noise channel (e.g., noise channel 305 of FIG. 3).

Referring to FIG. 4, FIG. 4 shows the Frobenius distance of successive orders of Magnus/Dyson from an exact computation of the noise channel for a CX_{π/2} gate when scanning the strength of a dense random dissipator matrix. Below a relative noise strength threshold, the perturbation is convergent and higher-order corrections provide more precise estimates. In particular, Magnus demonstrates a higher threshold for convergence and also yields lower error at a given order in comparison to Dyson, but at a higher computational cost. In this example, below a threshold of approximately 10% for Magnus, the perturbation is convergent. In one embodiment, starting from physically relevant coherent and incoherent noise, controlled noise constructor 203 employs perturbation for deriving leading-order symbolic results. In particular, the commutator structure of the Magnus solution is an effective tool for an analytical description of the interplay between the underlying noise and ideal gate, and for predicting how the locality of the physical noise is transformed. As a result, noise construction is improved by predicting the expected non-zero terms for a given gate based on certain dominant noise mechanisms. Furthermore, resources can be saved as learning higher-weight Pauli-Lindblad (PL) fidelities becomes more expensive.

In one embodiment, controlled noise constructor 203 is configured to compute the noise channel (e.g., noise channel 305 of FIG. 3) using the perturbative approach based on the analyzed Lindbladian (e.g., analyzed Lindbladian 304) by approximating the noise due to each process independently up to a first order, where the noise channel (e.g., noise channel 305 of FIG. 3) is computed based on a product of each approximate noise due to each process. For example,

$$𝒩 \approx {\prod }_{k} exp ( {Ω}_{k}^{( 1 )} ) .$$

By using such a perturbative method to compute the noise channel, such a computation is performed in a controlled manner which exploits the locality of noise to reduce the complexity yet results in an accurate noise channel that correctly predicts how the physical noise acts on the qubits.

Various applications of computing noise channels for multi-qubit quantum operations using the principles of the present disclosure have been previously discussed herein in connection with FIGS. 5-7 and will not be reiterated herein for the sake of brevity.

In step 906, quantum error mitigation/correction module 204 of classical computer 102 selects the appropriate quantum error mitigation or quantum error correction technique to be performed on the quantum circuit run on quantum hardware using the computed noise channel (e.g., noise channel 305 of FIG. 3).

Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation.

As discussed above, in order for quantum error mitigation and quantum error correction techniques to be successful, such techniques need a precise understanding of the noise channel that affects a layer of qubits, where the noise channel predicts how the physical noise acts on the qubits.

Referring to FIG. 3, quantum error mitigation/correction module 204 uses the constructed noise channel 305 to select the appropriate quantum error mitigation or quantum error correction technique to be implemented as shown in element 306 (mitigated/corrected observable expectation values). For example, the constructed noise channel 305 feeds into the quantum error mitigation/correction of choice which runs specific quantum circuits on the quantum hardware. In one embodiment, a data structure (e.g. table) stores a listing of the appropriate quantum error mitigation/quantum error correction techniques to be performed on the quantum circuit based on the constructed noise channel 305. In one embodiment, quantum error mitigation/correction module 204 performs a look-up in such a data structure in order to select the appropriate quantum error mitigation/correction technique to be performed on the quantum circuit run on the quantum hardware based on the constructed noise channel 305. In one embodiment, such a data structure is populated by an expert. In one embodiment, such a data structure resides within the storage device (e.g., storage device 811, 815) of classical computer 102.

An example of a quantum error mitigation technique is the zero noise extrapolation technique. Zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Examples of a quantum error correction technique include the Shor code and the surface code, which are both designed to detect and correct errors, such as bit-flip and phase-flip errors, by distributing quantum information across multiple physical qubits allowing for error identification and correction through syndrome measurements.

Quantum error mitigation/correction module 204 utilizes various software tools for performing quantum error mitigation/correction in the manner discussed above, including, but are not limited to, Mitiq, Qiskit®, Cirq®, PyQuil®, etc.

By using the perturbative method of the present disclosure to compute the noise channel, such a computation is performed in a controlled manner which exploits the locality of noise to reduce the complexity yet results in an accurate noise channel that correctly predicts how the physical noise acts on the qubits. Furthermore, such a computed noise channel is a noise channel of multi-qubit operations that is predicted without the need for twirling.

Furthermore, the principles of the present disclosure enable either a full (untwirled) or twirled noise channel to be perturbatively constructed. Additionally, such constructed noise can be used as a local building block to stitch/construct the noise of larger quantum systems thereby being applicable to arbitrary quantum circuits.

Furthermore, the principles of the present disclosure improve the technology or technical field involving quantum error mitigation/correction.

As discussed above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. That is, quantum error mitigation is a technique that reduces the effects of noise and error on measured observables. Quantum error correction refers to a set of techniques used in quantum computing to protect quantum information stored in qubits from errors caused by noise and decoherence by encoding information across multiple physical qubits to detect and correct errors that may occur during computation. In order for quantum error mitigation and quantum error correction techniques to be successful, such techniques need a precise understanding of the noise channel that affects a layer of qubits. A noise channel represents the various environmental factors that can disrupt the delicate quantum states of qubits leading to errors in computation. Such a noise channel may be computed using the Lindblad noise construction method, which computes the noise channel by exponentiating the learned Lindbladian (Lindbladian operator that has been derived or learned from data). The Lindblad noise construction method refers to a method for modeling noise within a quantum system using the Lindblad master equation, where noise is represented by a set of operators called the “Lindblad operators” that describe the possible decay and decoherence processes affecting the quantum system thereby allowing for the calculation of how a quantum state evolves over time under the influence of noise. Unfortunately, the calculation of exponentiating the learned Lindbladian becomes more complex as the number of qubits increases thereby making such a calculation impractical for large quantum systems. As a result, there is not currently a means for effectively computing a noise channel for a multi-qubit quantum operation.

Embodiments of the present disclosure improve such technology by receiving the learned Lindbladian describing the dynamics of a multi-qubit operation. A Lindbladian, as used herein, refers to a mathematical operator used to describe the evolution of an open quantum system, such as describing how a quantum system's density matrix changes over time when interacting with its environment. The learned Lindbladian, as used herein, refers to a Lindbladian operator that has been derived or learned from data, such as low-weight observable measurements. The learned Lindbladian is then analyzed, such as using the ideal gate Hamiltonian (H_{g}) on n qubits, to identify the noise terms. In one embodiment, such noise terms are identified by computing the interaction-frame Lindbladian with respect to the ideal gate Hamiltonian (H_{g}) on n qubits. A noise channel is then computed using a perturbative approach based on the identified noise terms. A perturbation, as used herein, refers to a small, controllable change or disturbance added to a quantum system so as to analyze how the original quantum system is affected by this added perturbation. Examples of the perturbation approach used to compute the noise channel include the Magnus expansion or the Dyson expansion. The Magnus expansion provides an exponential representation of the solution to a first-order homogeneous linear differential equation. The Dyson expansion involves expressing the time evolution operator as an infinite sum of terms, each representing a sequence of interactions occurring at different times thereby effectively describing how a quantum system evolves under a perturbation over time. By using such a perturbative method to compute the noise channel, such a computation is performed in a controlled manner which exploits the locality of noise to reduce the complexity yet results in an accurate noise channel that correctly predicts how the physical noise acts on the qubits. Furthermore, in this manner, there is an improvement in the technical field involving quantum error mitigation/correction.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for computing noise channels for multi-qubit quantum operations, the method comprising:
receiving a learned Lindbladian describing dynamics of a multi-qubit operation;
analyzing said learned Lindbladian to identify noise terms; and
computing a noise channel using a perturbative approach based on said identified noise terms.

2. The method as recited in claim 1, wherein said noise channel is computed using a Magnus expansion or a Dyson expansion as said perturbative approach.

3. The method as recited in claim 1 further comprising:
grouping noise terms in said learned Lindbladian in terms of coherent and incoherent contributions, which are categorized in orders of locality.

4. The method as recited in claim 1 further comprising:
decomposing said learned Lindbladian into a sum of underlying weight-k coherent and incoherent processes up to weight-k terms, wherein said weight-k specifies support of a coherent or incoherent Lindblad term involving k neighboring qubits.

5. The method as recited in claim 4 further comprising:
analyzing said learned Lindbladian to identify said noise terms using an ideal gate Hamiltonian on n qubits.

6. The method as recited in claim 1, wherein said noise channel is computed using said perturbative approach based on said analyzed Lindbladian by approximating noise due to each process independently up to a first order, wherein said noise channel is computed based on a product of each approximate noise due to each process.

7. The method as recited in claim 1 further comprising:
selecting a quantum error mitigation technique or a quantum error correction technique to be performed on a quantum circuit run on a quantum hardware based on said computed noise channel.

8. A computer program product for computing noise channels for multi-qubit quantum operations, the computer program product comprising one or more computer readable storage mediums having program code embodied therewith, the program code comprising programming instructions for:
receiving a learned Lindbladian describing dynamics of a multi-qubit operation;
analyzing said learned Lindbladian to identify noise terms; and
computing a noise channel using a perturbative approach based on said identified noise terms.

9. The computer program product as recited in claim 8, wherein said noise channel is computed using a Magnus expansion or a Dyson expansion as said perturbative approach.

10. The computer program product as recited in claim 8, wherein the program code further comprises the programming instructions for:
grouping noise terms in said learned Lindbladian in terms of coherent and incoherent contributions, which are categorized in orders of locality.

11. The computer program product as recited in claim 8, wherein the program code further comprises the programming instructions for:
decomposing said learned Lindbladian into a sum of underlying weight-k coherent and incoherent processes up to weight-k terms, wherein said weight-k specifies support of a coherent or incoherent Lindblad term involving k neighboring qubits.

12. The computer program product as recited in claim 11, wherein the program code further comprises the programming instructions for:
analyzing said learned Lindbladian to identify said noise terms using an ideal gate Hamiltonian on n qubits.

13. The computer program product as recited in claim 8, wherein said noise channel is computed using said perturbative approach based on said analyzed Lindbladian by approximating noise due to each process independently up to a first order, wherein said noise channel is computed based on a product of each approximate noise due to each process.

14. The computer program product as recited in claim 8, wherein the program code further comprises the programming instructions for:
selecting a quantum error mitigation technique or a quantum error correction technique to be performed on a quantum circuit run on a quantum hardware based on said computed noise channel.

15. A system, comprising:
a memory for storing a computer program for computing noise channels for multi-qubit quantum operations; and
a processor connected to said memory, wherein said processor is configured to execute program instructions of the computer program comprising:
receiving a learned Lindbladian describing dynamics of a multi-qubit operation;
analyzing said learned Lindbladian to identify noise terms; and
computing a noise channel using a perturbative approach based on said identified noise terms.

16. The system as recited in claim 15, wherein said noise channel is computed using a Magnus expansion or a Dyson expansion as said perturbative approach.

17. The system as recited in claim 15, wherein the program instructions of the computer program further comprise:
grouping noise terms in said learned Lindbladian in terms of coherent and incoherent contributions, which are categorized in orders of locality.

18. The system as recited in claim 15, wherein the program instructions of the computer program further comprise:
decomposing said learned Lindbladian into a sum of underlying weight-k coherent and incoherent processes up to weight-k terms, wherein said weight-k specifies support of a coherent or incoherent Lindblad term involving k neighboring qubits.

19. The system as recited in claim 18, wherein the program instructions of the computer program further comprise:
analyzing said learned Lindbladian to identify said noise terms using an ideal gate Hamiltonian on n qubits.

20. The system as recited in claim 15, wherein said noise channel is computed using said perturbative approach based on said analyzed Lindbladian by approximating noise due to each process independently up to a first order, wherein said noise channel is computed based on a product of each approximate noise due to each process.
